(19) United States
(12) Patent Application Publication
(10) Pub. No.: US 2021/0229335 A1
(43) Pub. Date: Jul. 29, 2021

(54) METHOD AND DEVICE FOR MANUFACTURING A THERMALLY INSULATED PIPE

(71) Applicant: Brugg Rohr AG Holding, Brugg (CH)

(72) Inventor: Alfred Oeschger, Wil (CH)

(21) Appl. No.: 17/053,394

(22) PCT Filed: Apr. 25, 2019
(86) PCT No.: PCT/EP2019/060583

§ 371 Date: Nov. 6, 2020

(30) Foreign Application Priority Data
May 7, 2018 (CH) 00570/18

(51) Int. Cl. B29C 48/153; B29C 48/00; B29C 48/09; B29C 48/21; B29D 23/00

(52) U.S. Cl. CPC B29C 48/153; B29C 48/0017; F16L 59/147; B29C 48/21; B29D 23/001; B29C 48/09

(57) ABSTRACT

In the method for the continuous production of a heat-insulated, corrugated line pipe (1) with at least one inner pipe (2), a corrugated outer jacket of the line pipe is first produced by means of an extruder (27) and a corrugator (28) and the inner pipe arranged in a foil tube together with a foam-forming starting material is guided into the corrugator, in which the outer jacket of the line pipe which has been corrugated before is filled with the heat-insulating foam. The device (10) provided for carrying out the method has a protective pipe (26) by means of which the inner pipe surrounded by the foil tube can be guided separately from the extrusion and corrugation of the outer jacket into the corrugator.

### CROSS-REFERENCE TO RELATED APPLICATIONS

This application is a National Stage application of International Patent Application No. PCT/EP2019/060583, filed on Apr. 25, 2019, which claims priority to Swiss Patent Application No. 00570/18 filed on May 7, 2018, each of which is hereby incorporated by reference in its entirety.

### TECHNICAL FIELD

The invention relates to a method for the continuous production of a pipe according to the preamble of claim 1. Furthermore, the invention relates to a device for producing such a pipe.

### BACKGROUND

Thermally insulated, corrugated pipes are well known and are used, for example, for district heating supply. Such pipes are also used to transport liquids or gases for other applications, especially in the oil and gas industry. A well-known method for their continuous production is described in EP 0 897 788 A1. In this method, at least one inner pipe is wrapped in a foil tube and plastic material is inserted into the foil tube, which foams up and forms the thermal insulation. After passing through forming jaws to form the corrugation, the outer jacket is extruded onto the corrugated surface of the tube. This method has proven to be successful. In order to achieve a deep corrugation, which is preferred for the windability of the line pipe for transport and for enabling small radii during its installation, WO 2010/085906 A1 proposes to process the line pipe with additional forming tools during its production after the extruder. This allows a deep corrugation to be achieved, but the method is complex and extends the production line. WO 2014/122278 A1 proposes to achieve a very flexible pipe and a manufacturing device with low space requirements by extruding the outer jacket directly onto the still expanding composite of foil tube and thermal insulation and passing the resulting composite of still expanding thermal insulation and the smooth outer jacket through a corrugator in which the thermal insulation and the outer jacket expand further together. The outer jacket material is pressed by the expanding thermal insulation foam into the recesses of the corrugator. A further method is known from WO 2008/142211 A1. An inner pipe surrounded by cured PU foam is wrapped with a PE mat, after which a foil is tightly wrapped around the PE mat. The corrugated jacket is applied to this composite in a corrugator, wherein the heat causes the foil to burst and the PE mat to expand to its original state, clamping the insulated pipe in the corrugated jacket.

### SUMMARY

The objective of the invention is to create a further manufacturing method. This shall produce a pipe with a deep corrugation and thus high flexibility.

In a manufacturing method of the type mentioned above, this is achieved by feeding the outer jacket separately from the inner pipe, which is surrounded by the foil tube, into the corrugator and forming it in the corrugator, whereupon the foaming of the thermal insulation takes place in the already formed outer jacket.

In the present invention or the method for the continuous production of a heat-insulated, corrugated line pipe with an inner pipe, the corrugated outer jacket is thus first produced with an extruder and with a corrugator and the inner pipe arranged in a foil tube together with a foam-forming starting material is led into the corrugator, in which the outer jacket of the line pipe previously formed in the corrugator is filled with the heat-insulating foam. The method is also well suited for the production of pipes with a very thin thermal insulation.

The corrugation of the outer jacket in the corrugator takes place independently of the foaming pressure, which enables a very well controllable formation or shaping of the corrugated outer jacket without any defects in the outer jacket and, if desired, with a large corrugation depth. The foam formation which only takes place in the already formed outer jacket has no significant influence on the shape of the outer jacket, especially since the foam formation after the previous formation of the corrugated outer jacket is preferably still taking place in the corrugator in which the outer jacket is held stable. For the formation of the outer jacket in the corrugator, a vacuum-corrugator is used in particular, in which the forming is carried out by a vacuum acting between the corrugator's mould parts and the outer jacket to be formed.

In order to ensure that the foaming only takes place in the corrugator, a mixture of starting materials is used to form the insulating foam, the reactivity of which is adjusted so that, depending on the speed of the production line for the line pipe and the temperature conditions, the foaming reaction only takes place in the corrugator. Usually, a two-component mixture is used, in particular comprising polyol and isocyanate to form a polyurethane foam. In particular, the reactivity is adjusted in such a way that the foam is formed after 10 seconds to 60 seconds and particularly after 15 seconds to 20 seconds. With the specified starting time, the foam formation occurs mainly only after the formation of the finished formed outer jacket in the corrugator or the mixture of the foam-forming components is still liquid when it arrives in the corrugator—lying in the foil forming the foil tube. In addition or alternatively, the foam formation of the starting material in the foil tube is influenced by cooling as it passes through the extruder.

Preferably, the method is carried out in such a way that a protective pipe running through the extruder is used, in which the inner pipe surrounded by the foil tube is led through the extruder, whereby the protective pipe runs into the closed mould parts of the corrugator. The outer jacket is corrugated in the corrugator above the protective pipe. Preferably, the protective pipe is provided on the outside and preferably also on the inside with a friction-reducing coating, particularly with a coating containing or consisting of polytetrafluoroethylene (PTFE). The outside coating prevents the outer jacket material exiting the extruder from sticking to the protective pipe if the outer material, which normally comes directly from the extruder into the vacuum zone of the corrugator, should come into contact with the protective pipe, which is not intended but can happen. Usually the outer jacket material is high-density polyethylene (HDPE) or another plastic material used for the outer jacket of the above-mentioned type of line pipes, whereby its adhesion to the protective pipe can be avoided by a PTFE coating or other adhesion and friction reducing coating of the protective pipe. Preferably, the protective pipe is adjustable in the longitudinal direction of the extruder, whereby the position of the front end of the protective pipe in the corrugator can be adjusted. This allows the protective pipe to be fed into the corrugator until the outer jacket is completely formed before it is exposed to the foaming pressure of the forming thermal insulation foam.

It is desired that the foil of the foil tube, which is pressed by the expanding foam against the inner side of the corrugated outer jacket, is bonded or welded to the outer jacket under the effect of the existing process heat. This is the case with a foil made of polyethylene (PE). Advantageously, a polyethylene (PE) coated foil can particularly also be used, particularly a polyamide foil coated on both sides with polyethylene, the advantage of which is a higher temperature resistance. Advantageously, a foil with a low thickness of 0.01 to 0.20 mm and particularly with a thickness of 50 μm to 120 μm is used.

Furthermore, the invention has the objective to provide a device for the production of a thermally insulated, corrugated line pipe.

This objective is reached with a device according to claim 11.

The device for carrying out the method thus has a protective pipe, by means of which the inner pipe surrounded by the foil tube can be guided separately from the extrusion and corrugation of the outer jacket into the corrugator.

Preferably, the device is designed so that the end of the protective pipe guided into the corrugator is located in the area of the corrugator in which the mould blocks of the corrugator are completely closed. Preferably, the protective pipe is held in the device in such a way that it can be adjusted in its longitudinal direction. Furthermore, it is preferable that a cooling device is provided by which the protective pipe can be cooled within the extruder, whereby foaming that occurs too early can be easily avoided. Furthermore, the device is preferably designed in such a way that the protective pipe is provided with a friction-reducing coating on the outside and inside.

### BRIEF DESCRIPTION OF THE DRAWINGS

Further embodiments, advantages and applications of the invention result from the dependent claims and from the following description of the figures. It is thereby shown in:

FIG. 1 is an illustrative, partially cut representation of a thermally insulated, corrugated line pipe;

FIG. 2 a roughly schematic side view of a device for the continuous production of a line pipe;

FIG. 3 is a schematic top view of the area of the device where the extrusion of the outer jacket and the creation of the corrugated shape (the corrugation) takes place; and

FIG. 4 a schematic side view of the device of FIG. 3.

### DETAILED DESCRIPTION

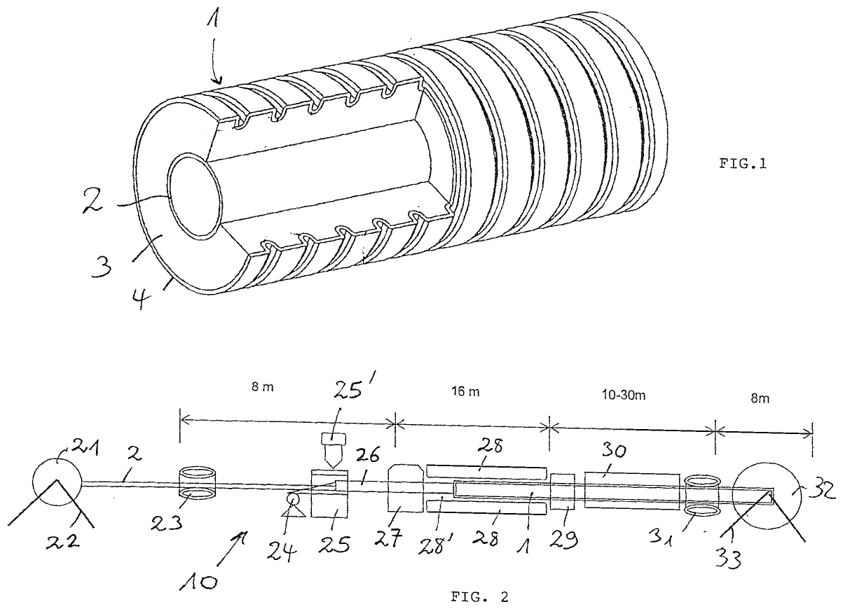

FIG. 1 shows a section of a thermally insulated, corrugated line pipe 1 as it can be produced continuously and in long lengths by the method. The line pipe 1 has an inner pipe 2 of plastic or metal, a foamed thermal insulation 3 of plastic, particularly polyurethane foam, and a corrugated outer jacket 4 of plastic. The outside diameter of such pipes is in particular in the range of 70 mm to 350 mm. The line pipe shown is only an example and for better understanding of the invention explained below. Line pipes manufactured according to the invention may in particular have more than one inner pipe. They may have a corrugation, which differs in shape and depth from the corrugation shown. Furthermore, a line pipe manufactured according to the method may also behave in such a way that the thermal insulation foam does not lie against the outer jacket at all points, especially not in the peaks of the corrugations. Thus, cavities can remain in the wave crests of the outer jacket. This can be desirable and result in greater flexibility of the pipe.

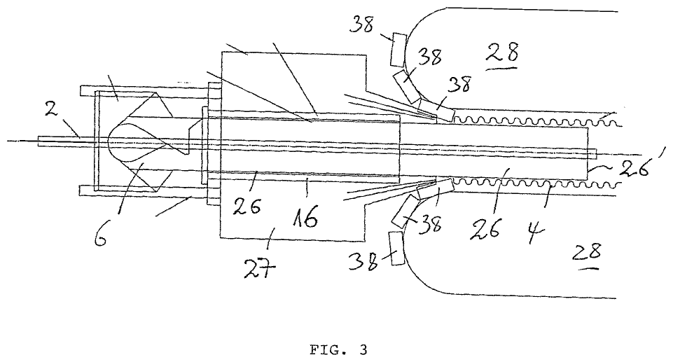

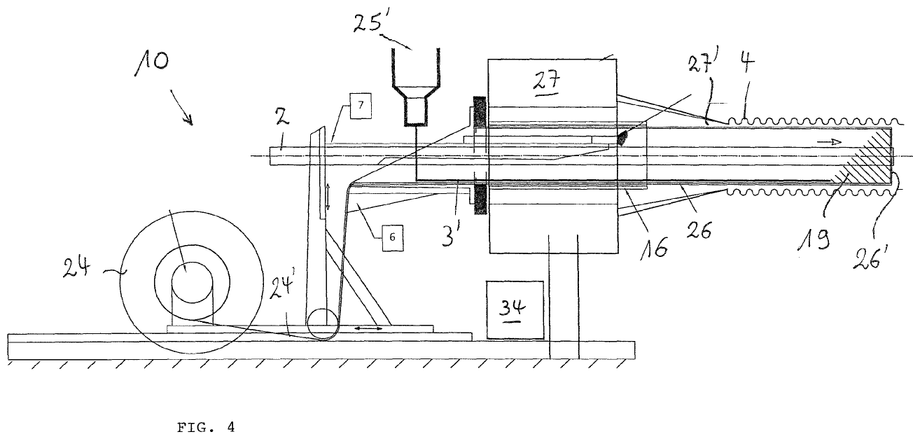

FIG. 2 shows a rough schematic of a device 10 for carrying out the method for the purpose of an overview. The special method steps and device features are shown in more detail below using FIGS. 3 and 4. On the far left of FIG. 2 a supply reel 21 is shown, which is arranged on a device 22 and from which the inner pipe 2 is unwound during the production of the line pipe 1. If several inner pipes are provided in the line pipe, several coils are provided accordingly. In the present invention, the inner pipes used do not differ from the inner pipes conventionally used by the skilled person, which may consist of plastic or metal. A guide 23 leads the inner pipe 2 to a station 25, in which the foil unwound from a roll of foil 24 is formed in a known manner into a foil tube, which is initially still open along its longitudinal seam and surrounds the inner pipe 2. The reaction components, which subsequently form the foamed thermal insulation 3 of the line pipe 1, are introduced into the still open foil tube. For this, a mixing head 25′ is shown schematically. This is also known to the skilled person and will not be further explained here. In station 25, the protective pipe 26, which is explained in more detail below, can also start, lying in longitudinal direction of the essentially linearly arranged device 10. The inner pipe 2 with the foil tube and the still liquid reaction components is fed through the extruder 27 in the protective pipe 26.

The extrudate exits from extruder 27 and enters the mould parts of the corrugator 28, in which the outer jacket 4 of the line pipe 1 is given the desired corrugation shape and finished. This takes place in the area 28′, in which the inner pipe 2 surrounded by the foil tube still runs in the protective pipe 26. When the inner pipe 2 leaves the protective pipe 26, the expanding thermal insulation foam can fill the already corrugated outer jacket 4 to form the pipe 1. This filling preferably takes place inside the corrugator 28. A measuring device 29 known to the skilled person, which follows the corrugator 28, checks whether the inner pipe 2 is centered in the line pipe 1 within the given tolerance. A cooling station 30 and a transport port 31 that pulls the pipe and a winding station 33 for forming a coil 32 of the finished pipe 1 follow.

The production speed of the device can, for example, be between 3 m/min and 6 m/min. FIG. 2 gives examples of lengths in meters for different sections of the device as a guide.

FIGS. 3 and 4 show schematically in top and side view a part of the device 10 for a more detailed explanation of the method. The same reference signs as used in FIGS. 1 and 2 indicate identical or functionally identical elements. It can be seen how the inner pipe 2 enters a pipe guide 7. The height of this guide is adjustable in height from the base of the device 10, which is shown by the double arrow. To form the foil tube, the foil 24′ unwound from the foil wrap 24 is placed around the inner pipe 2 by means of a mould part 6 and fed into the extruder 27 together with the inner pipe, and the longitudinal seam of the foil tube is closed in the known manner, in particular at least partially welded. Prior to this, the components forming the thermal insulation foam are introduced into the foil tube in liquid form via the mixing head 25′ and are present there as a still liquid mixture 3′.

The protective pipe 26 runs in longitudinal direction of the device in extruder 27. The inner pipe 2 with the foil tube is fed through the extruder inside the protective pipe. The free end 26′ of the protective pipe 26 lies in the corrugator 28.

The extrusion of the material of the outer jacket 4 of the line pipe is carried out by the extruder 27 in a manner basically known to the skilled person. The plastic outer jacket material, for example HDPE, is melted in the extruder and leaves the annular outlet 27′ of the extruder 27 as extrudate. This is done completely separated from the inner pipe, which is separated from the extruder by the protective pipe inside the protective pipe. The corrugated outer jacket 4 can then be produced in the corrugator. The extruded outer jacket material is fed directly into the corrugator 28 from the extruder. The corrugator 28 is shown in FIG. 3 schematically and partly with three mould parts 38 or mould halves for the corrugation and with the transport means for the moulded parts shown only as a line, since the corrugator is an element known to the skilled person, which is operated here in a basically known manner. Of course, the corrugator has more mould parts and forms in a known way a form that runs along with the outer jacket 4 over a given length. The mould parts 38 close above the protective pipe 26 shortly after the outlet of the extruder 27 and form the rotating closed form. To simplify the drawing, the corrugator is not shown in FIG. 4. The mould parts, usually mould halves, surround the extruded material of the outer jacket and, in its still deformable state when it leaves the extruder, deform it to the corrugated shape given by the mould parts. The outer jacket material formed in this way thus forms outer jacket 4 for the line pipe 1. The forming is carried out in the corrugator in a known manner by a vacuum, which acts on the extruded material through the mould parts or mould halves and thereby pulls the outer jacket material into the mould parts to form the corrugated outer jacket 4. As shown in FIGS. 3 and 4, the outer jacket 4 is formed in the corrugator, while the inner tube 2 with the foil tube and the reaction components inside still runs in the protective pipe 26, which extends into the corrugator.

The starting time for the reaction of the reaction components filled into the foil tube via the mixing head is set in such a way that the foam formation and thus the so-called foam front mainly occurs only in the end area of the protective pipe or after the end 26′ of the protective pipe. In FIG. 4, the foam front 19 is shown as a hatched area for the example shown here. Starting from the components that are initially still liquid in the protective tube or in the foil tube, the rising foam front 19 develops. The thermal insulation foam then fills the outer jacket previously formed in the corrugator after the protective pipe 26, or the filling of the outer jacket 4 with the thermal insulation foam 3 takes place at the foam front. The outer jacket 4 is supported against the foaming pressure by the moulded parts of the corrugator. The rising zone or the foam front 19 starts in the corrugator only after the outer jacket has been completely formed in the corrugator.

The starting time of the component mixture that forms the thermal insulation foam must be set according to the length of the manufacturing device from the point where the reaction components are filled into the foil tube to the end of the protective pipe where the reaction begins and according to the production speed for the line pipe in meters per second. This setting for the start of the reaction can be adjusted in the range of 10 seconds to 60 seconds and particularly in the range of 15-20 seconds. The setting of such a reaction time or start time is known to the skilled person, and corresponding components for the foam formation are commercially available and their start time is defined. If necessary, a retarding agent can be added to the foam components. In the present method, a flexible PUR insulating foam is preferably used and the polyol and isocyanate components used for its production are known to the skilled person with the setting of the start time.

Preferably, a coolant for the protective pipe is provided in extruder 27 around the outside of protective pipe 26, for example in the form of a cooling coil surrounding it or a cooling pipe 16, as shown in FIGS. 3 and 4. The cooling pipe 16 is in heat flow connection with a conventional cooling unit of the device 10, which is only indicated as block 34. This causes a cooling of the cooling pipe 16 and thus of the protective pipe 26 running in the extruder 27 in this cooling pipe 16. The protective pipe 26 can be cooled in the extruder to a temperature that, as an example, is in the range of 10 degrees Celsius to 20 degrees Celsius and is in particular around 15 degrees Celsius. The cooling is preferably provided in order to keep the reaction time or start time of the components for the formation of the thermal insulation foam more precisely or to make it independent of the heat generation of the extruder.

The protective pipe 26 is preferably provided with a friction-reducing coating, for example a PTFE coating, at least in the extrusion area of the extruder, which prevents the extruded outer jacket material from sticking to the protective pipe. Although it is not extruded onto the protective pipe, the extrudate may come into contact with the protective pipe. On the inside, the protective pipe 26 is also provided with a friction-resistant coating, particularly a PTFE coating. This allows the foil tube to slide along the inner surface of the protective pipe with as little friction as possible.

As material for the foil tube, a PE foil already known for this purpose can be used. When the thermal insulation foam is foamed, this foil bonds with the still hot inner surface of the outer jacket 4. A composite foil can also be used, for example a foil produced with the layer sequence PE-PA-PE. An advantage of a foil with polyamide is its excellent temperature resistance, particularly up to 200 degrees Celsius, compared to a pure PE foil. Preferably, a thin foil with a thickness in the range of 0.01 mm to 0.20 mm and particularly with a thickness of 50 micrometers to 120 micrometers is used for the foil tube. A thin foil facilitates the penetration of the thermal insulation foam into the already formed cavities of the corrugation of the outer jacket, if this is desired for the manufactured line pipe 1. In other words, by choosing a comparatively thicker foil, the filling of the cavities can be reduced or largely prevented, if this is desired.

It is also preferable to adjust the length of the protective pipe inside the device 10 in order to adjust the length of the end 26′ of the protective pipe in the corrugator. This allows the end of the protection tube to be adjusted to the range in which the outer jacket is completely formed.

In the present invention or the method for the continuous production of a heat-insulated, corrugated line pipe 1 with an inner pipe 2, the corrugated outer jacket is thus first produced with an extruder 27 and with a corrugator 28 and the inner pipe 2, which is arranged in a foil tube together with a foam-forming starting material, is guided with delayed foam formation into the corrugator, in which the previously corrugated outer jacket of the line pipe is filled with the heat-insulating foam. The device 10 provided for the execution of the method has a protective pipe 26, by means of which the inner pipe surrounded by the foil tube can be guided separately from the extrusion and corrugation of the outer jacket into the corrugator.

While the present application describes preferred embodiments of the invention, it must be clearly stated that the invention is not limited there and can be implemented in other ways within the scope of the following claims.

What is claimed is:

1. A method for the continuous production of a line pipe, which line pipe comprises at least an inner pipe, a foamed thermal insulation and a corrugated outer jacket of plastic, comprising the steps
forming a foil tube around the at least one inner pipe and introducing the foam-forming starting material for forming the foamed thermal insulation into the foil tube,
passing the inner pipe with the foil tube through an extruder, by means of which the outer jacket is extruded in a ring shape, and
generating the corrugated shape of the outer jacket in a corrugator,
wherein
the outer jacket is fed into the corrugator separately from the inner pipe surrounded by the foil tube and formed in the corrugator, and in that
the formation of the foamed thermal insulation takes place in the previously corrugated outer jacket.

2. The method according to claim 1, wherein the forming of the outer jacket in the corrugator is carried out by using vacuum for forming.

3. The method according to claim 1, wherein a foam-forming starting material is used, the reaction time or start time of which is adjustable.

4. The method according to claim 3, wherein a foam-forming starting material is used, the reaction time or start time of which is adjustable from 10 seconds to 60 seconds, and in particular a foam-forming starting material is used, the reaction time or start time of which is adjustable from 15 seconds to 20 seconds.

5. The method according to claim 1, wherein the formation of the foamed thermal insulation is delayed by cooling, wherein in particular when the inner pipe with the foil tube is passed through the extruder, cooling of the foil tube with the starting material contained therein for the formation of the foamed thermal insulation is effected.

6. The method according to claim 1, wherein the inner pipe surrounded by the foil tube is guided through the extruder by means of a protective pipe, wherein the protective pipe is guided into the closed mould parts of the corrugator.

7. The method according to claim 6, wherein the protective pipe is provided on the inside, preferably also on the outside, with a friction-reducing coating, in particular with a coating containing polytetrafluoroethylene (PTFE) or consisting thereof.

8. The method according to claim 6, wherein the protective pipe is adjustable in longitudinal direction of the extruder and wherein the position of its front end in the corrugator is adjusted in such a way that the outer jacket is completely formed in the section of the corrugator extending around the protective pipe.

9. The method according to claim 1, wherein a foil coated with polyethylene (PE) is used to form the foil tube, in particular a polyamide foil coated on one or both sides with polyethylene.

10. The method according to claim 1, wherein a foil with a thickness of 0.01 mm to 0.20 mm, in particular with a thickness of 50 μm to 120 μm, is used for the formation of the plastic tube.

11. A device for the continuous production of a line pipe which has at least one inner pipe, a foamed thermal insulation surrounding the inner pipe and a corrugated outer jacket, which device comprises, in substantially linear sequence, a first device for unwinding the inner pipe from a supply reel, a second device for forming a foil tube around the at least one inner pipe and for introducing a foam-forming starting material into the foil tube, and an extruder, a corrugator and a device for winding the line pipe emerging from the corrugator, wherein a protective pipe is provided leading through the extruder and lying in longitudinal direction of the device, which extends into the corrugator, in which protective pipe the inner pipe surrounded by the foil tube can be guided through the extruder in such a way that the extrudate produced by the extruder is corrugated in the corrugator separately from the inner pipe guided in the protective pipe.

12. The device according to claim 11, wherein the end of the protective pipe guided into the corrugator lies in the region of the corrugator in which the mould parts of the corrugator are completely closed.

13. The device according to claim 11, wherein the protective pipe is held in the device in such a way that it can be displaced adjustably in its longitudinal direction.

14. The device according to claim 11, wherein a cooling device is provided, by means of which the protective pipe is cooled within the extruder.

15. The device according to claim 11, wherein the protective pipe is provided on the inside, preferably also on the outside, with a friction-reducing coating, in particular with a coating containing or consisting of polytetrafluoroethylene (PTFE).

16. The method according to claim 2, wherein a foam-forming starting material is used, the reaction time or start time of which is adjustable.

17. The method according to claim 2, wherein the formation of the foamed thermal insulation is delayed by cooling, wherein in particular when the inner pipe with the foil tube is passed through the extruder, cooling of the foil tube with the starting material contained therein for the formation of the foamed thermal insulation is effected.

18. The method according to claim 3, wherein the formation of the foamed thermal insulation is delayed by cooling, wherein in particular when the inner pipe with the foil tube is passed through the extruder, cooling of the foil tube with the starting material contained therein for the formation of the foamed thermal insulation is effected.

19. The method according to claim 4, wherein the formation of the foamed thermal insulation is delayed by cooling, wherein in particular when the inner pipe with the foil tube is passed through the extruder, cooling of the foil tube with the starting material contained therein for the formation of the foamed thermal insulation is effected.

20. The method according to claim 2, wherein the inner pipe surrounded by the foil tube is guided through the extruder by means of a protective pipe, wherein the protective pipe is guided into the closed mould parts of the corrugator.
